(19) United States
(12) Patent Application Publication
(10) Pub. No.: US 2020/0082991 A1
(43) Pub. Date: Mar. 12, 2020

(54) CAPACITOR, CAPACITOR PACKAGE STRUCTURE AND METHOD OF MANUFACTURING THE SAME

(71) Applicant: ANDAQ TECHNOLOGY CO., LTD., Taipei City (TW)

(72) Inventor: CHIA-YU WU, NEW TAIPEI CITY (TW)

(21) Appl. No.: 16/412,617

(22) Filed: May 15, 2019

(30) Foreign Application Priority Data
Sep. 12, 2018 (TW) 107132060

(51) Int. Cl. H01G 9/00; H01G 9/15; H01G 9/028; H01G 9/14; H01G 9/042; H01G 9/08

(52) U.S. Cl. CPC H01G 9/0003; H01G 9/151; H01G 9/15; H01G 9/028; H01G 9/012; H01G 9/0425; H01G 9/08; H01G 9/0036; H01G 9/14

(57) ABSTRACT

A capacitor, a capacitor package structure, and a method of the manufacturing the capacitor are provided. The capacitor includes a conductive polymer material. The conductive polymer material is made of a solution containing a plurality of conductive polymer particles. A particle size of each of the conductive polymer particles is at least smaller than 30 nm, so that the capacitance decay may less than 10% when the capacitor receives a surge current. In addition, the capacitor package structure includes a conductive polymer material. The conductive polymer material is made of a solution containing a plurality of conductive polymer particles. The particle size of the conductive polymer particle is at least smaller than 30 nm, so that the capacitance decay may less than 10% when the capacitor package receives a surge current.

This application claims the benefit of priority to Taiwan Patent Application No. 107132060, filed on Sep. 12, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor, a capacitor package structure and a method of manufacturing the same, and more particularly to a capacitor, a capacitor package structure and a method thereof which have a capacitance decay of at least 10% when receiving a surge current.

### BACKGROUND OF THE DISCLOSURE

Capacitors have been widely used in consumer appliances, computer motherboards and their peripherals, power supplies, communication products, and automotive basic components. The main functions of capacitors include filtering, bypassing, rectification, coupling, decoupling, and switching, and thus capacitors are considered one of the indispensable components in electronic products. According to different materials and uses, capacitors have different types, including aluminum electrolytic capacitors, tantalum electrolytic capacitors, laminated ceramic capacitors, and film capacitors. In the related art, the solid electrolytic capacitor has the advantages of small size, large capacitance, superior frequency characteristics, and can decouple the power supply circuit for the central processing unit. However, when receiving the surge current, the capacitance decay of capacitors of the related art may be greater than 10%, which seriously affects the electrical characteristics of the capacitor, and thus capacitors of the related art still have room for improvement.

### SUMMARY OF THE DISCLOSURE

In response to the above-referenced technical inadequacies, the present disclosure provides a capacitor, a capacitor package structure and a method of manufacturing the same.

In one aspect, the present disclosure provides a capacitor including at least one conductive polymer material. The at least one of the conductive polymer materials is made of a solution containing a plurality of conductive polymer particles. The conductive polymer particles have a particle diameter of at least 30 nm, so that when the capacitor receives a surge current a capacitance decay generated is at least less than 10%.

In one aspect, the present disclosure provides a capacitor package structure including at least one conductive polymer material, and at least one of the conductive polymer materials being made of a solution contains a plurality of conductive polymer particles, the conductive polymer particles have particle diameter of at least 30 nm so that when the capacitor receives the surge current, the capacitance decay generated is at least less than 10%.

In one aspect, the present disclosure provides a method of manufacturing the same, including: providing a conductive component; disposing at least one capacitor on the conductive component, the conductive component including at least one positive conductive pin and at least one negative conductive pin separated from at least one of the positive conductive pins; and forming a package structure to cover all of the at least one of the capacitors and a portion of the conductive component. At least one of the capacitors includes at least one conductive polymer material, and at least one of the conductive polymer materials is made of a solution containing a plurality of conductive polymer particles having a particle diameter of at least less than 30 nm, so that when the capacitor receives the surge current, the capacitance decay generated is at least less than 10%.

Therefore, one of the beneficial effects of the present disclosure is that the capacitor, the capacitor package structure and the manufacturing method provided by the present disclosure, are capable of adopting the solution of “capacitor including at least one conductive polymer material, at least one of the conductive polymer materials is made of a solution containing a plurality of conductive polymer particles, and the conductive polymer particles have a particle diameter of at least less than 30 nm” or “the capacitor package structure including at least one conductive polymer material, at least one of the conductive polymer materials is made of a solution containing a plurality of conductive polymer particles, and the conductive polymer particles have a particle diameter of at least less than 30 nm”, so that when the capacitor receives the surge current, the capacitance decay generated is at least less than 10%.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a capacitor according to a first embodiment of the present disclosure.

FIG. 2 is an enlarged schematic view showing portion II of FIG. 1.

FIG. 3 is a cross-sectional view showing a first capacitor package structure according to the first embodiment of the present disclosure.

FIG. 4 is a cross-sectional view showing a second capacitor package structure according to the first embodiment of the present disclosure.

FIG. 5 is a cross-sectional view showing a capacitor of a second embodiment of the present disclosure.

FIG. 6 is a side cross-sectional view showing a capacitor package structure according to the second embodiment of the present disclosure.

FIG. 7 is a flow chart showing a method of manufacturing a capacitor package structure according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

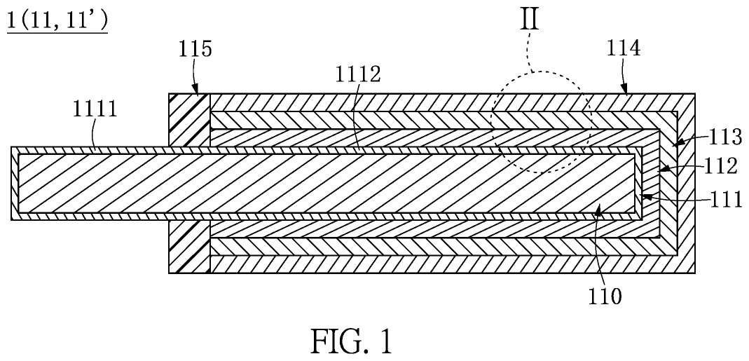

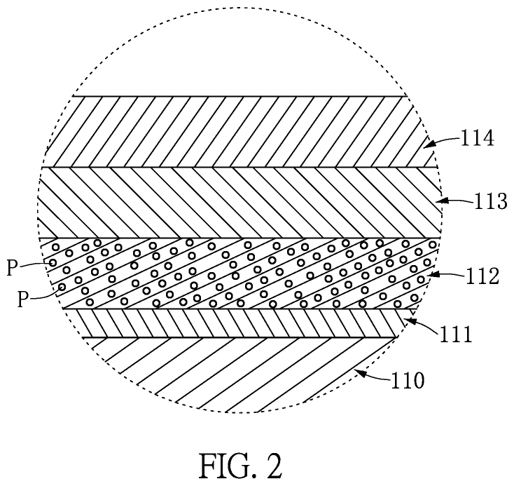

Referring to FIG. 1 to FIG. 2, a first embodiment of the present disclosure provides a capacitor 1 including at least one electrically conductive polymer material, and at least one electrically conductive polymer material is made of a solution containing a plurality of electrically conductive polymer particles P. In addition, the diameter of the conductive polymer particles P can be at least less than (or not exceeded) 30 nm, so that when the capacitor receives a surge current a capacitance decay generated is at least less than 10%. That is, since the diameter of the conductive polymer particles P can be at least less than 30 nm, when the capacitor 1 receives the surge current, the percentage of the capacitance decay generated by the capacitor 1 is at least less than 10% or no more than 10%.

For example, as shown in FIG. 1 and FIG. 2, the capacitor 1 can be a stacked capacitor unit 11 including: a metal foil 110, an oxide layer 111, a conductive polymer layer 112, a carbon layer 113 and a silver layer 114. An oxide layer 111 is formed on the outer surface of the metal foil 110 to completely cover the metal foil 110. The conductive polymer layer 112 is formed on the oxide layer 111 to partially cover the oxide layer 111. The carbon layer 113 is formed on the conductive polymer layer 112 to cover the conductive polymer layer 112. A silver layer 114 is formed on the carbon layer 113 to cover the conductive polymer layer 112. It should be noted that the conductive polymer layer 112 may be made of at least one conductive polymer material including a plurality of conductive polymer particles P, and the particle diameter of all or at least 80% of the plurality of conductive polymer particles P can be at least less than 30 nm, for example, less than 25 nm or smaller than 25 nm. However, the present disclosure is not limited thereto.

As described above, the metal foil 110 may be aluminum, copper or any metal material according to different usage requirements, and the surface of the metal foil 110 has a porous corrosion layer, so that the metal foil 110 may be a corrosion foil with the porous corrosion layer. When the metal foil 110 is oxidized, the oxide layer 111 is formed on the surface of the metal foil 110, and the metal foil 110 with the oxide layer 111 formed on the surface thereof may be referred to as a valve metal foil. However, the present disclosure is not limited thereto.

Furthermore, as shown in FIG. 1 and FIG. 2, the stacked capacitor unit 11 further includes: a reinforced barrier layer 115 formed around an outer surface of the oxide layer 111 to divide the outer surface of the oxide layer 111 into a first part outer surface 1111 and a second part outer surface 1112 separated from each other. In addition, the conductive polymer layer 112 is formed on the second part outer surface 1112 of the oxide layer 111 and completely covers the second part outer surface 1112 of the oxide layer 111. The carbon layer 113 is formed on an outer surface of the conductive polymer layer 112 and completely covers the outer surface of the conductive polymer layer 112. The silver layer 114 is formed on an outer surface of the carbon layer 113 and completely covers the outer surface of the carbon layer 113. The distance from an outer peripheral surface of the reinforced barrier layer 115 relative to the oxide layer 111 may be greater than, less than, or equal to the distance of an outer peripheral surface of the silver layer 114 from the oxide layer 111. However, the present disclosure is not limited thereto.

As described above, an end of the conductive polymer layer 112, an end of the carbon layer 113, and an end of the silver layer 114 contact or separate the reinforced barrier layer 115 so that the length of the conductive polymer layer 112, the length of the carbon layer 113 and the length of the silver layer 114 are limited by the reinforced barrier layer 115. In addition, according to different usage requirements, the reinforced barrier layer 115 may be a conductive layer made of any conductive material (such as Al or Cu), or an insulating layer made of any insulating material (such as epoxy or silicon). It should be noted that, the capacitor 1 may not use the reinforced barrier layer 115 depending on different usage requirements. However, the present disclosure is not limited thereto.

Furthermore, as shown in FIG. 1 to FIG. 4, the first embodiment of the present disclosure further provides a capacitor package structure S. The capacitor package structure S includes at least one conductive polymer material made of a solution containing a plurality of conductive polymer particles P. In addition, the particle diameter of the conductive polymer particles P can be at least less than 30 nm, so that in the moment the capacitor package structure S receives the surge current, the capacitance decay generated can be at least less than 10%. That is, since the particle diameter of the conductive polymer particles P can be at least less than 30 nm, when the capacitor package structure S receives the surge current, the percentage of the capacitance decay generated by the capacitor package structure S is at least less than 10% and no more than 10%.

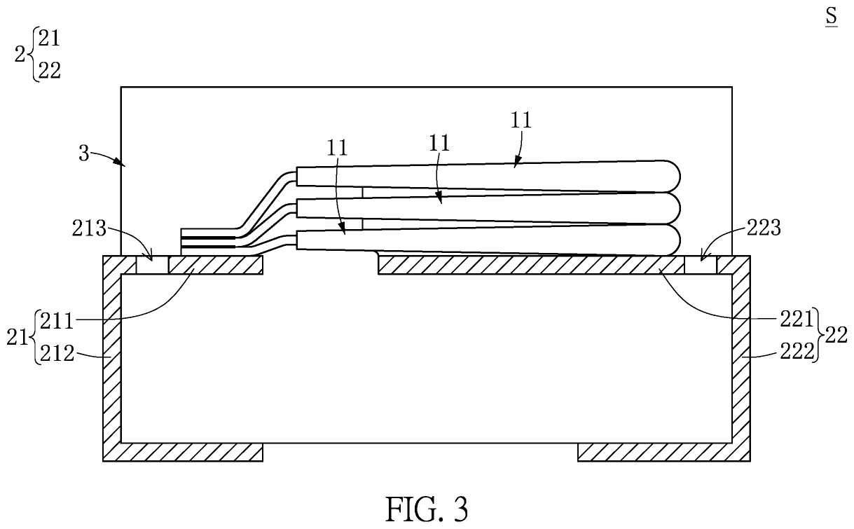

For example, as shown in FIG. 3, the capacitor package structure S further includes: a conductive component 2, a plurality of first stacked capacitor units 11 and the package structure 3. The conductive component 2 includes at least one positive conductive pin 21 and at least one negative conductive pin 22 separated from the at least one positive conductive pin 21. The plurality of first stacked capacitor units 11 are sequentially stacked and disposed between the at least one positive conductive pin 21 and the at least one negative conductive pin 22. The package structure 3 covers all the plurality of first stacked capacitor units 11 and a portion of the conductive component 2. Further, at least one positive conductive pin 21 has a first embedded part 211 covered in the interior of the package structure 3 and a first exposed part 212 exposed on the outside of the package structure 3, and at least one positive conductive pin 21 has at least a first through-hole 213 extending through the first embedded part 211 and filled by the package structure 3. The at least one negative conductive pin 22 has a second embedded part 221 covered in the interior of the package structure 3 and a second exposed part 222 exposed on the outside of the package structure 3, and the at least one negative conductive pin 22 has at least one second through-hole 223 penetrating through the second embedded part 221 and filled by the package structure 3. Therefore, the capacitor package structure S can be a stacked capacitor package structure adopting the method of the single layer stack. However, the present disclosure is not limited thereto.

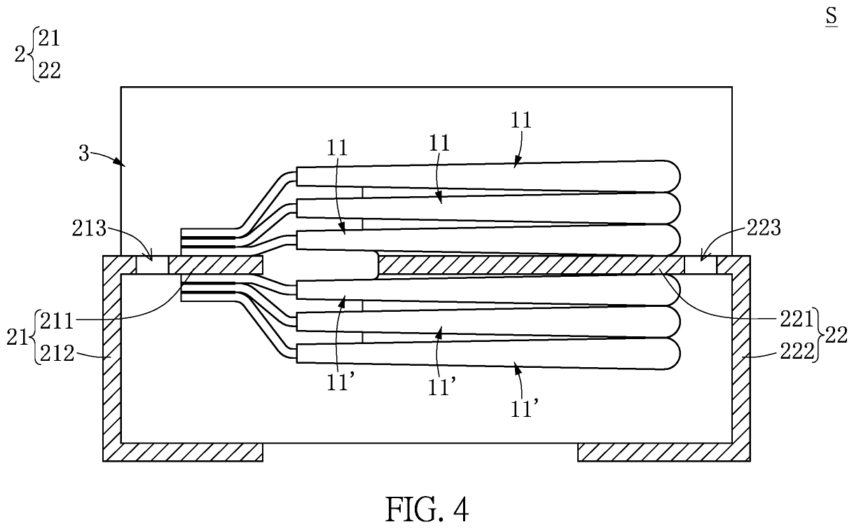

For example, as shown in FIG. 4, the capacitor package structure S further includes: a plurality of second stacked capacitor units 11′ sequentially stacked and disposed between the at least one positive conductive pin 21 and the at least one negative conductive pin 22. In addition, the plurality of second stacked capacitor units 11′ are all covered by the package structure 3, and the first stacked capacitor unit 11 and the second stacked capacitor unit 11′ are respectively located on opposite side ends of the conductive component 2. Therefore, the capacitor package structure S can be a stacked capacitor package structure using a two-layer stack. However, the present disclosure is not limited thereto.

It is should be noted that the solid electrolytic capacitor is a solid electrolyte instead of a liquid electrolyte as a cathode, and the conductive polymer has been widely used as a cathode material of a solid electrolytic capacitor based on its high conductivity and easy process. The conductive polymer material comprises materials such as polyaniline (PAni), polypyrrole (PPy) and polythiophene (PTh) and derivatives thereof. In addition, the polydioxyethylthiophene-polystyrene sulfonic acid polymer (PEDOT:PSS) composite has excellent electrical conductivity, and compared with other polymers such as PAni and PPy, the PEDOT:PSS composite has a higher conductivity. Since the polymerization rate is low, the polymerization can be carried out at normal temperature to reduce the difficulty of preparation. In addition, the PEDOT:PSS composite has better weather resistance and heat resistance than other polymers. Also, the PEDOT:PSS composite has good dispersibility, low production cost, high transparency, and excellent processability. Therefore, using the PEDOT:PSS composite as a raw material to form the conductive polymer layer 3 on the cathode part of the capacitor contributes greatly to the improvement of the electrical effect of the capacitor.

### Second Embodiment

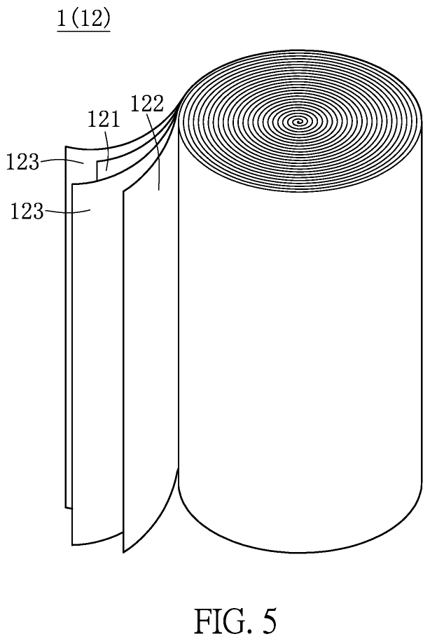

Referring to FIG. 5, a second embodiment of the present disclosure provides the capacitor 1 including at least one electrically conductive polymer material, and at least one conductive polymer material made of a solution containing a plurality of conductive polymer particles (not shown). In addition, the conductive polymer particles may have a particle diameter of at least less than 30 nm, so that when receiving the surge current a capacitance decay induced by the capacitor 1 can be at least less than 10%. That is, since the particle diameter of the conductive polymer particles can be at least less than 30 nm, when the capacitor 1 receives the surge current, the percentage of decay of the capacitance generated by the capacitor 1 is at least less than 10% and is not greater than 10%.

For example, as shown in FIG. 5, the capacitor 1 may be a winding capacitor unit 12, and the winding capacitor unit 12 includes: a winding positive electrode conductive foil 121, a winding negative electrode conductive foil 122 and two winding spacers 123 (such as a interleaving paper or any insulating sheet). In addition, one of the two winding spacers 123 is disposed between the winding positive electrode conductive foil 121 and the winding negative electrode conductive foil 122. It should be noted that the winding separator 123 can be adhered with at least one conductive polymer material by an impregnation method, and the conductive polymer material is made of a solution containing a plurality of conductive polymer particles. That is, the at least one conductive polymer material solution including the plurality of conductive polymer particles is prepared, and then the winding spacer 123 is impregnated into the conductive polymer material solution to make the at least one conductive polymer. The material can be filled into the inside of the winding spacer 123 or attached to the outer surface of the winding spacer 123. However, the present disclosure is not limited thereto.

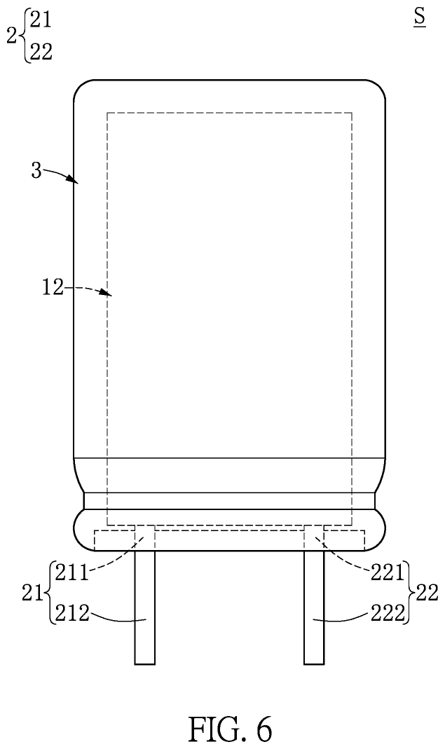

Furthermore, referring to FIG. 5 and FIG. 6, the second embodiment of the present disclosure further provides a capacitor package structure S. The capacitor package structure S includes at least one conductive polymer material, and at least one conductive polymer material made of a solution containing a plurality of conductive polymer particles. In addition, the conductive polymer particles can have a particle diameter of at least less than 30 nm, so that when the capacitor receives a surge current a capacitance decay generated is at least less than 10%. That is, since the particle diameter of the conductive polymer particles can be at least less than 30 nm, when the capacitor package structure S receives the surge current, the percentage of the capacitance decay generated by the capacitor package structure S is at least less than 10%, or will not be greater than 10%. However, the present disclosure is not limited thereto.

For example, the capacitor package structure S further includes: a winding capacitor unit 12, a package structure 3, and a conductive component 2. The winding capacitor unit 12 is wrapped inside the package structure 3. The conductive component 2 includes a first conductive pin 21 electrically contacting the winding positive electrode foil 121 and a second conductive pin 22 electrically contacting the winding negative electrode foil 122. Further, the first conductive pin 21 has a first embedded part 211 covered in the interior of the package structure 3 and a first exposed portion 212 exposed on the outside of the package structure 3, and the second conductive pin 22 has a second embedded part 221 covered in the interior of the package structure 3 and a second exposed part 222 exposed on the outside of the package structure 3. It should be noted that the winding spacer 123 can be adhered with at least one conductive polymer material by an impregnation method, and the conductive polymer material is made of a solution containing a plurality of conductive polymer particles. However, the present disclosure is not limited thereto.

### Third Embodiment

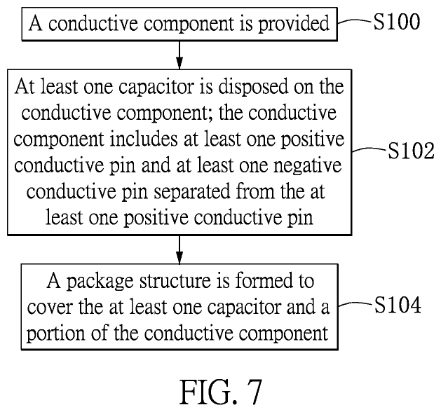

Referring to FIG. 7 and FIG. 1 to FIG. 6, a third embodiment of the present disclosure provides a method for manufacturing a capacitor package structure, including: first, providing a conductive component 2 (S100); next, at least one capacitor 1 is disposed on the conductive component 2, the conductive component 2 includes at least one positive conductive pin 21 and at least one negative conductive pin 22 separated from the at least one positive conductive pin 21 (S102); then, a package structure 3 is formed to cover the at least one capacitor 1 and a portion of the conductive component 2 (S104). For example, under the condition of introducing at least one oxidizing agent the plurality of conductive polymer particles P are synthesized in at least one conductive polymer material, and the at least one oxidizing agent may be oxygen, hydrogen peroxide or any oxygen-containing oxidizing agent.

It should be noted that at least one capacitor 1 includes at least one conductive polymer material, and at least one conductive polymer material is made of a solution containing a plurality of conductive polymer particles P. In addition, the particle diameter of the conductive polymer particles P can be at least less than 30 nm, so that when the capacitor 1 receives the surge current the capacitance decay generated can be at least less than 10%. That is, since the particle diameter of the conductive polymer particles P can be at least less than 30 nm, when the capacitor 1 receives the surge current, the percentage of the capacitance decay generated by the capacitor 1 is at least less than 10% or no more than 10%. For example, the capacitor 1 may be a stacked capacitor unit 11, a second stacked capacitor unit 11′ or a winding capacitor unit 12. However, the present disclosure is not limited thereto.

In conclusion, one of the beneficial effects of the present disclosure is that the capacitor 1, the capacitor package structure S and the manufacturing method provided by the present disclosure, are capable of adopting the solution of “capacitor 1 including at least one conductive polymer material, at least one of the conductive polymer materials is made of a solution containing a plurality of conductive polymer particles P, and the conductive polymer particles P have a particle diameter of at least less than 30 nm” or “the capacitor package structure S structure including at least one conductive polymer material, at least one of the conductive polymer materials is made of a solution containing a plurality of conductive polymer particles P, and the conductive polymer particles P have a particle diameter of at least less than 30 nm” so that when the capacitor 1 or the capacitor package structure S receives the surge current, the capacitance decay generated is at least less than 10%.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A capacitor comprising at least one conductive polymer material, wherein the at least one conductive polymer material is made of a solution containing a plurality of conductive polymer particles, and the conductive polymer particles have particle diameter of at least 30 nm, so that when the capacitor receives a surge current a capacitance decay generated is at least less than 10%.

2. The capacitor according to claim 1, wherein the capacitor is a stacked capacitor unit, and the stacked capacitor further comprising:
a metal foil;
an oxide layer formed on an outer surface of the metal foil to completely cover the metal foil;
a conductive polymer layer formed on the oxide layer to partially cover the oxide layer;
a carbon layer formed on the conductive polymer layer to cover the conductive polymer layer; and
a silver layer formed on the carbon layer to cover the conductive polymer layer;
wherein the conductive polymer layer is made of the at least one conductive polymer material including the plurality of conductive polymer particles, and all or at least 80% of the plurality of the conductive polymer particles have particle diameter less than 25 nm.

3. The capacitor according to claim 2, wherein the stacked capacitor unit further includes: a reinforced barrier layer circumferentially formed on an outer surface of the oxide layer to divide the outer surface of the oxide layer into a first part outer surface and a second part outer surface that are separated, and the conductive polymer layer is formed on the second part outer space of the oxide layer and completely covers the second part outer space of the oxide layer; wherein the carbon layer is formed on an outer surface of the conductive polymer layer and completely covers the outer surface of the conductive polymer layer, and the silver layer is formed on an outer surface of the carbon layer and completely covers the outer surface of the carbon layer, and a distance of an outer peripheral surface of the reinforced barrier layer relative to the oxide layer is greater than, less than or equal to a distance of an outer peripheral surface of the silver layer relative to the oxide layer; wherein an end of the conductive polymer layer, an end of the carbon layer, and an end of the silver layer are in contact with or separated from the reinforced barrier layer, so that the length of the conductive polymer layer, the length of the carbon layer and the length of the silver layer are limited by the reinforced barrier layer.

4. The capacitor according to claim 1, wherein the capacitor is a winding capacitor unit, and the winding capacitor further including:
a winding positive electrode conductive foil;
a winding negative electrode conductive foil; and
two winding spacers, and one of the two winding space disposed between the winding positive electrode conductive foil and the winding negative electrode conductive foil;
wherein the winding spacer is attached to the at least one of the conductive polymer materials including a plurality of the conductive polymer particles by an impregnation method;
wherein all or at least 80% of the plurality of the conductive polymer particles have particle diameter of at least less than 30 nm.

5. A capacitor package structure comprising at least one conductive polymer material, wherein the at least one of the conductive polymer materials is made of a solution containing a plurality of conductive polymer particles, the conductive polymer particles have particle diameter of at least 30 nm so that when the capacitor receives a surge current a capacitance decay generated is at least less than 10%.

6. The capacitor package structure according to claim 5, further comprising:
a conductive component including at least one positive conductive pin and at least one negative conductive pin separated from at least one of the positive conductive pins; and
a plurality of first stacked capacitor units, wherein the plurality of first stacked capacitor units are sequentially stacked and disposed between at least one of the positive conductive pins and at least one of the negative conductive pins, each of the stacked capacitor unit includes:
a metal foil
an oxide layer formed on an outer surface of the metal foil to completely cover the metal foil;
a conductive polymer layer formed on the oxide layer to partially cover the oxide layer;
a carbon layer formed on the conductive polymer layer to cover the conductive polymer layer;
a silver layer formed on the carbon layer to cover the conductive polymer layer; and
a package structure covering a plurality of the first stacked capacitor units and a portion of the conductive component;
wherein all or at least 80% of the plurality of conductive polymer particles have a particle diameter of at least less than 25 nm.

7. The capacitor package structure according to claim 6, further comprising: a plurality of second stacked capacitor units, wherein the plurality of second stacked capacitor units are sequentially stacked and disposed between the at least one of the positive conductive pins and the at least one of the negative conductive pins, and the plurality of stacked capacitor units are all covered by the package structure, and the first stacked capacitor units and the second stacked capacitor units are respectively located on opposite side ends of the conductive component; wherein at least one of the positive conductive pin has a first embedded part covered by the package structure and a first exposed part exposed outside the package structure, and at least one of the positive conductive pins has a through-hole extending through the first embedded part and filled by the package structure; wherein at least one of the negative conductive pins has a second embedded part covered by the package structure and a second exposed part exposed outside the package structure, and at least one of the negative conductive pins has at least one second through-hole extending through the second embedded part and filled by the package structure.

8. The capacitor package structure according to claim 5, further comprising:
a winding capacitor unit including a winding positive electrode conductive foil, a winding negative electrode conductive foil and two winding spacers, wherein one of the two winging spacers is disposed between the winding positive electrode conductive foil and the winding negative electrode conductive foil, and one of the winding positive electrode conductive foil and the winding negative electrode conductive foils is disposed between the two of the winding spacers;
a package structure, wherein the winding capacitor unit is wrapped inside the package structure; and
a conductive component including a first conductive pin electrically contacting the winding positive electrode conductive foil and a second conductive pin electrically contacting the winding negative electrode conductive foil, wherein the first conductive pin has a first embedded part embedded inside the package structure and a first exposed part exposed outside the package structure, and the second conductive pin has a second embedded part that is embedded inside the package structure and a second exposed part that is exposed outside the package structure,
wherein the winding spacer is attached to at least one of the conductive polymer materials including a plurality of the conductive polymer particles by an impregnation method;
wherein all or at least 80% of the plurality of the conductive polymer particles have a particle diameter of at least less than 30 nm.

9. A method of manufacturing the same, comprising
providing a conductive component;
disposing at least one capacitor on the conductive component containing at least one positive conductive pin and at least one negative conductive pin separated from at least one of the positive conductive pins; and
forming a package structure to cover at least one of the capacitors and a portion of the conductive component;
wherein at least one of the capacitors includes at least one conductive polymer material, and at least one of the conductive polymer materials is made of a solution containing a plurality of conductive polymer particles having a particle diameter of at least less than 30 nm, so that when the capacitor receives a surge current a capacitance decay generated is at least less than 10%.

10. The method of manufacturing the same according to claim 9, wherein the plurality of conductive polymer particles are synthesized in at least one of the conductive polymer materials under the condition of introducing at least one oxidizing agent, and at least one of the oxidizing agents is oxygen or hydrogen peroxide; wherein all or at least 80% of the plurality of conductive polymer particles have a particle diameter of at least less than 30 nm.
